(19) United States
(12) Patent Application Publication
(10) Pub. No.: US 2026/0118943 A1
(43) Pub. Date: Apr. 30, 2026

(54) MANAGING DATA PROCESSING SYSTEMS USING POWER-BASED COMMUNICATIONS

(71) Applicant: Dell Products L.P., Round Rock, TX (US)

(72) Inventors: CHRISTOPHER BAUER ATKINSON, Woodstock, GA (US); KIRK FREY, Flemington, NJ (US); ETHAN A. KALEY, North Kingstown, RI (US)

(21) Appl. No.: 18/931,602

(22) Filed: Oct. 30, 2024

(51) Int. Cl. G06F 1/3287; G06F 1/3209

(52) U.S. Cl. CPC G06F 1/3287; G06F 1/3209

(57) ABSTRACT

Methods and systems for managing a data processing system are disclosed. Based on an occurrence of a power management event for the data processing system, the data processing system may use a multi-function connection to exchange power information with a power distribution unit (PDU) that supplies power to the data processing system via the multi-function connection. Using the power information, a power management process may be performed to obtain a new powered state for the data processing system. The new powered state may be enforced on hardware resources of the data processing system to obtain an updated processing system usable for providing computer-implemented services.

### FIELD

Embodiments disclosed herein relate generally to managing data processing systems. More particularly, embodiments disclosed herein relate to systems and methods for managing power distribution to the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIG. 1C shows a block diagram illustrating an example of a power distribution system in accordance with an embodiment.

FIG. 2 shows an interaction diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services to downstream consumers. To provide the computer-implemented services, the data processing system may be powered via a power distribution system. The power distribution system may convert large scale power input (e.g., from a utility power grid) to small scale power (e.g., usable by a data processing system), and may distribute the converted power to a deployment of data processing systems. The power distribution system may include multiple power distribution units (PDUs) and other components (e.g., power panels, transfer switches, back-up generators) that participate in distributing power to the deployment.

Each PDU of the power distribution system may provide power to a number of data processing systems connected to each of the PDUs via distinct power connections. Each PDU may be capable of supplying a limited amount of power to the connected data processing systems in a period of time (e.g., based on power ratings for each of the PDUs). However, power demands of the connected data processing systems may vary, and may vary over time. Therefore, to optimize power distribution to the data processing systems (e.g., to reduce likelihoods of (i) overloading some PDUs with power demands and/or (ii) underutilizing power available via other PDUs), power resources may be allocated within the deployment based on limits of power supplied by each PDU and limits of power consumed by connected data processing systems over time. To do so, the architecture of the power distribution system (e.g., a layout of power connections between the data processing systems and the PDUs) may be required to be known.

However, due to a complex and dynamic architecture of the power distribution system, identifying and/or verifying power connections between each data processing system and each power port of each PDU of the power distribution system may be tedious, resource intensive, and/or may disrupt the provisioning of the computer-implemented services. For example, manual efforts to identify power connections between the PDUs (e.g., power ports thereof) and the data processing systems may be subject to human error, and scanning methods (e.g., performing resets of each PDU of the power distribution system, modulating and monitoring changes in power demanded by each data processing system of the deployment), may interrupt critical processes and/or may not provide sufficiently detailed information for mapping the power connections.

Thus, to improve power distribution for the deployment, connections used to power the data processing systems via the PDUs may include multi-function connections. The multi-function connections may be adapted to both supply power to the data processing systems from the PDUs, and facilitate communication between the data processing systems and the PDUs. For example, a PDU that provides power to a data processing system via the multi-function connection may exchange data with the data processing system via the multi-function connection. The data may include power information usable to verify the architecture of the power distribution system (e.g., to map PDU power port and data processing system connections), and to proactively manage power distribution for the deployment over time.

By doing so, power distribution for the deployment may be managed using power-based communications over existing multi-function connections, without requiring additional types of connections. As a result, the deployment may be more likely to provide desired (e.g., reliable, uninterrupted and/or otherwise expected) computer-implemented services.

In an embodiment, a method for managing a data processing system is provided. The method may include making an identification, by a power manager of the data processing system, of an occurrence of a power management event for the data processing system.

The method may include, based on the identification: performing, by the data processing system and using a multi-function connection, a power information exchange process with a power distribution unit (PDU) that supplies power to at least the data processing system, the multi-function connection being adapted to both supply power to the data processing system and facilitate communication between the data processing system and the PDU to exchange power information; performing, by at least the data processing system, a power management process using the power information to obtain a new powered state for the data processing system; enforcing the new powered state on at least hardware resources of the data processing system to obtain an updated data processing system; and, providing, using the updated data processing system, computer-implemented services.

The PDU may be connected to at least two data processing systems via distinct multi-function connections. The PDU may be adapted to obtain data center level power and supply power source level power via the distinct multi-function connections.

The data processing system may be connected to the PDU via an out-of-band communication channel that runs through a network module of the data processing system and the out-of-band communication channel may service a management controller of the data processing system. The data processing system may be connected to at least one other entity via an in-band communication channel that also runs through the network module and the in-band communication channel may service the hardware resources.

The power information exchange process may be performed while power is being distributed via the multi-function connection. Performing the power information exchange process may include encoding data onto a carrier signal distributed via the multi-function connection to facilitate the exchange of the power information.

The power information may include at least one selected from a group consisting of: an identifier for the PDU; an identifier for a power source of the data processing system; a rating for the PDU; a rating for the power source; information regarding power supplied by the PDU over time; and, information regarding power consumption by the power source over time.

The power management process may include: obtaining limits of power consumption for the data processing system; and, defining the new powered state for the data processing system based on the limits of the power consumption.

A non-transitory media may include computer instructions that when executed by a processor cause the computer-implemented method to be performed.

The data processing system may include the non-transitory media and a processor, and may perform the computer-implemented method when the computer instructions are executed by the processor.

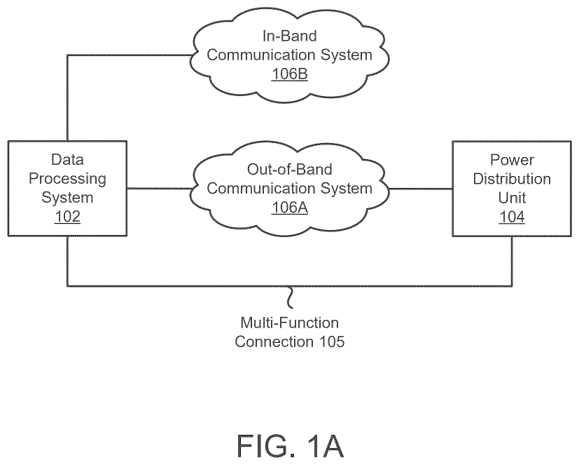

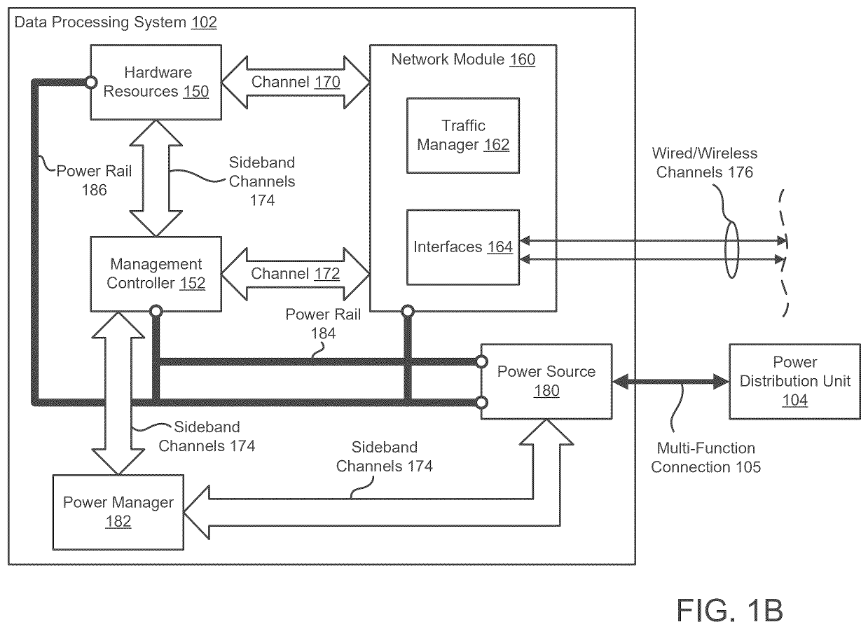

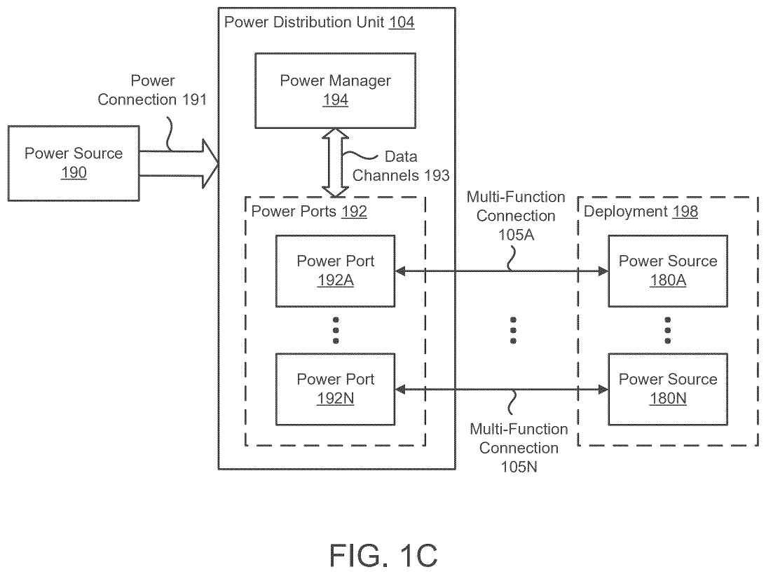

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device.

To provide the computer-implemented services, the distributed system may include a deployment of any number of data processing systems. Each data processing system of the deployment may include hardware resources (e.g., hardware and/or software components) and may independently and/or in some combination with other data processing systems of the deployment, provide a portion of the computer-implemented services. The data processing systems may each include a power source that provides power to the hardware resources, and each power source may be supplied with power through distinct power connections to components of a power distribution system.

The power distribution system may include various components for obtaining data center level power and supplying power source level power (e.g., usable by the power sources of the data processing systems) via the distinct power connections. For example, the power distribution system may include power panels, transfer switches, back-up generators, power distribution units (PDUs), and/or other components that participate in distributing power (e.g., converting power and/or otherwise managing the supply of power) to the each of the power sources.

For example, to provide power to the data processing systems, at least a portion of the PDUs of the power distribution system may be connected to (e.g., via a power cable) a group of data processing systems. The amount of power provided to the group of data processing systems may be limited by a power rating of the PDU (e.g., a maximum limit on power provided per unit time). Therefore, the power consumption by the group of data processing systems may be limited, in part, by the PDU.

Power consumption among different data processing systems of the deployment may vary, and the power consumption of each data processing system may vary over time. For example, different types of workloads (e.g., heavy workloads, light workloads) may require different quantities of power over different periods of time, and the workloads may be distributed among the deployment based on a variety of potentially contradictory factors, such as hardware resource requirements for each workload, hardware resource availability over time, and/or time factors. Therefore, if power consumption by the data processing systems is not managed appropriately, then some PDUs may become overloaded with power demands, while power supplied by other PDUs may go unused. This may result in interruptions to the computer-implemented services and/or inefficient use of limited power resources.

To manage power consumption by the data processing systems within the limits of their corresponding PDUs, a mapping of power connections between each data processing system and PDU (e.g., PDU power port) may be required to be known. However, the architecture of the power distribution system may be complex and may change over time (e.g., as data processing systems are removed from the deployment, added to the deployment, and/or as existing connections are modified over time), making it difficult to identify power connection mappings. For example, identifying each power connection mapping may require resource intensive manual efforts subject to human error, and other methods (e.g., rolling outages, intentional modifications to power consumption by each data processing system) may interrupt critical processes and/or may not provide sufficiently detailed information for identifying the power connection mappings (e.g., at the power port level).

In general, embodiments disclosed herein may provide methods, systems, and/or devices for managing power consumption by data processing systems using power-based communications. To do so, the connections used to power the data processing systems may include multi-function connections that both supply power to the data processing systems via the PDUs and facilitate communication between the data processing systems and the PDUs. Using the multi-function connections, power information may be exchanged between the PDUs and the data processing systems while power is being distributed.

The power information may include information usable to identify real-time power connections between the data processing systems and PDUs, and to proactively manage power consumption by each of the data processing systems over time. By doing so, power connections may be mapped (e.g., continuously, in real-time), and limited power resources may be more likely to be allocated in a manner that optimizes power distribution within the deployment.

To provide the above-mentioned functionality, the distributed system of FIG. 1A may include data processing system 102, power distribution unit 104, and any number of communication systems (e.g., out-of-band communication system 106A, in-band communication system 106B). The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems. For example, data processing system 102 may include a single data processing system, a group of data processing systems (e.g., powered via a power port of a PDU of the power distribution system), and/or a deployment of data processing systems (e.g., groups of data processing systems powered via multiple PDUs of the power distribution system). Data processing system 102 may provide computer-implemented services while hardware resources of data processing system 102 are operational (e.g., powered). In the example shown in FIG. 1A, data processing system 102 may be connected to power distribution unit 104. For example, power may be provided to data processing system 102 from power distribution unit 104 via multi-function connection 105.

Multi-function connection 105 may include a power connection (e.g., a power cable) adapted to both (i) supply power to data processing system 102, and (ii) facilitate at least one-way communication between connected entities (e.g., data processing system 102 and power distribution unit 104). For example, a component of data processing system 102 (e.g., a power source) may transmit power information to power distribution unit 104 (and/or may obtain power information from power distribution unit 104) via multi-function connection 105 using power-line communication technology.

Power distribution unit 104 may include at least one of any number of PDUs of a power distribution system that distributes power to a deployment including data processing system 102. Power distribution unit 104 may include any type of PDU, such as a basic PDU, a smart metered PDU, a switched PDU, an intelligent rack PDU, etc., and may include any number and/or type of power ports (e.g., power receptacles). In addition to use in PDUs, other types of power provisioning devices may include similar functionality. For example, other types of power provisioning devices may include smart outlets, smart receptacles, smart surge protectors, smart power strips, and/or other devices that may regulate distribution of power from a source of power (e.g., utility level power).

Power distribution unit 104 may supply power to at least data processing system 102 (e.g., as well as other data processing systems of the deployment). For example, power distribution unit 104 may supply power to data processing system 102 via multi-function connection 105, and to other data processing systems via distinct multi-function connections similar to multi-function connection 105.

To manage power distribution to data processing system 102, power distribution unit 104 may include functionality for communicating with operably connected devices. For example, power distribution unit 104 may include a component such as a power manager (e.g., a microcontroller) adapted to transmit power information to data processing system 102 (and/or to obtain power information from data processing system 102) via multi-function connection 105 using power-line communication technology. Refer to the discussion of FIG. 1C for more information regarding power distribution to data processing system 102.

To manage power consumption by the hardware resources of data processing system 102, data processing system 102 may include a power manager. The power manager may, for example, identify occurrences of power management events for data processing system 102. The occurrences of the power management events may indicate a change in a level of power consumption requirements for the hardware resources (e.g., the change exceeding a consumption threshold) and/or a change in a level of power available for supply to the hardware resources (e.g., the change exceeding a supply threshold). For example, an occurrence of a power management event may trigger a policy for data processing system 102 that defines a new powered state for the hardware resources, and operation of the hardware resources may be managed to enforce the new powered state.

To manage the operation of the hardware resources, data processing system 102 may include out-of-band components. The out-of-band components may include functionality for managing operation of the hardware resources and/or communicating with other devices using out-of-band methods (e.g., exchanging data with the other devices using out-of-band communication channels that circumvent in-band communication channels servicing the hardware resources). For example, the out-of-band components may provide power information to a management entity of data processing system 102 and/or obtain other types of information from the management entity to manage the operation of the hardware resources with respect to power consumption. Refer to the discussion of FIG. 1B for more information regarding components of data processing system 102.

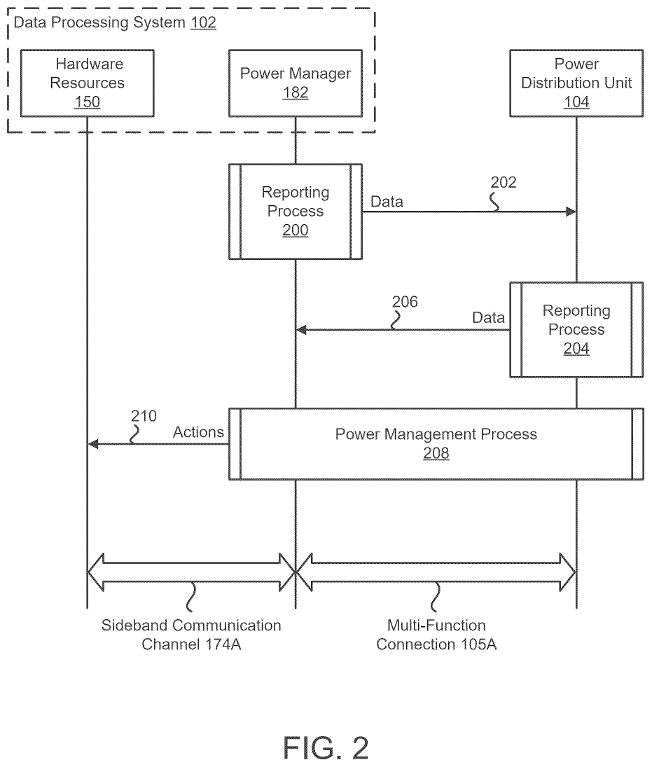

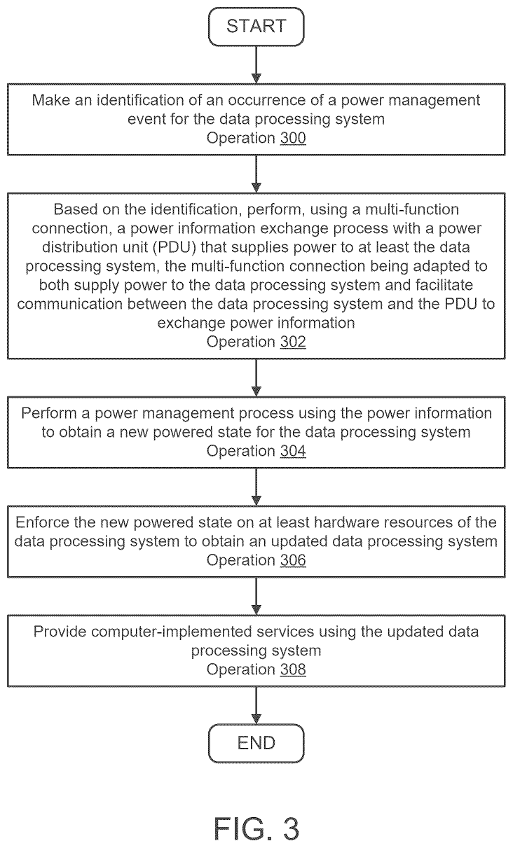

When providing their functionality, any of data processing system 102, power distribution unit 104, and/or components thereof may perform all, or a portion of the actions and methods illustrated in FIGS. 2-3.

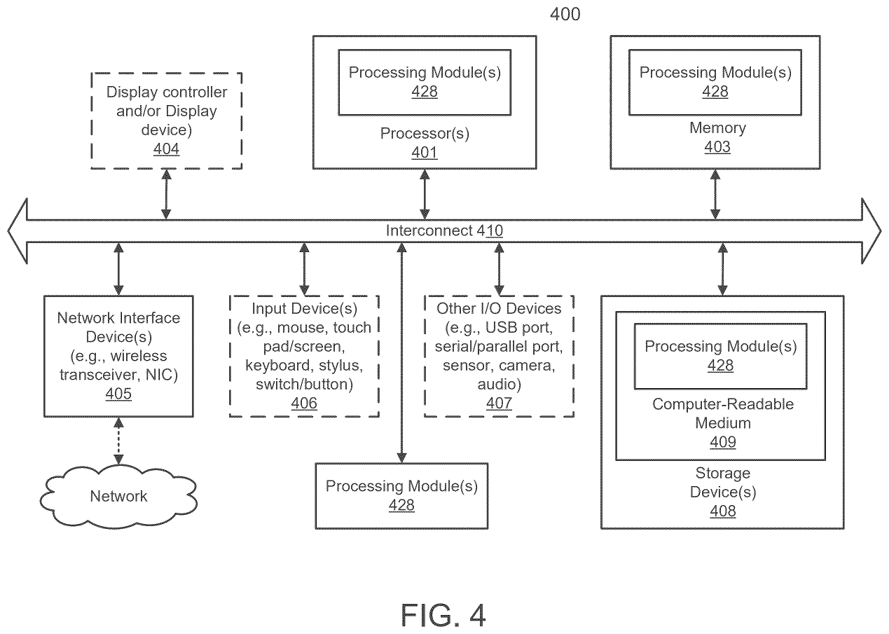

Any of data processing system 102 and power distribution unit 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with a communication system. The communication system may facilitate communications between the components of FIG. 1A. In an embodiment, the communication system includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

For example, the communication system may include out-of-band communication system 106A and in-band communication system 106B. Out-of-band communication system 106A may facilitate communication between the out-of-band components of data processing system 102, power distribution unit 104, and/or other devices connected to out-of-band communication system 106A; whereas in-band communication system 106B may facilitate communication between in-band components of data processing system 102 and other entities (e.g., devices) connected to in-band communication system 106B. While shown separately in FIG. 1A, out-of-band communication system 106A and in-band communication system 106B may be the same communication system.

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. Management controller 152 may, for example, monitor various ongoing processes performed by the in-band components, may manage power distribution, thermal management, and/or may perform other functions for managing data processing system 102.

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels). The sideband channels may be implemented using separate physical channels, and/or with a logical channel overlay over existing physical channels (e.g., logical division of in-band channels).

The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, when managing power consumption by hardware resources 150, management controller 152 may use sideband channels 174 to initiate and/or perform, at least in part (e.g., in cooperation with hardware resources 150), actions for enforcing a new powered state on hardware resources 150.

To reduce the likelihood of indirect compromise of an application hosted by hardware resources 150, management controller 152 may, for example, enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102 via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system 102. To do so, network module 160 may include traffic manager 162, and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These components may support any number of wired/wireless channels 176.

Thus, from the perspective of an external device, the in-band components and out-of-band components of data processing system 102 may appear to be two independent network entities that may be independently addressable and/or otherwise unrelated to one another.

To power hardware resources 150 and/or other components of data processing system 102, data processing system 102 may include power source 180. Power source 180 may include any type of power source (e.g., a power supply, a battery, etc.) and may distribute power to hardware resources 150 and/or the other components (e.g., management controller 152) via power rails 186 and/or 184. Power source 180 may provide an amount of power consistent with ratings for power source 180 (e.g., maximum power output, efficiency). Power source 180 may obtain a supply of power from a PDU (e.g., power distribution unit 104) via a multi-function connection (e.g., multi-function connection 105, multi-function connections 105A-105N shown in FIG. 1C and FIG. 2.). For example, multi-function connection 105 may be connected to a receptacle of power source 180 and a receptable (e.g., a power port) of power distribution unit 104.

Power source 180 may include components for obtaining power and/or data (e.g., power information) from power distribution unit 104. For example, power source 180 may include components adapted to filter data signal from power signal. Power source 180 may include components for providing data (e.g., power information) to power distribution unit 104. For example, power source 180 may include a component adapted to encode data onto a carrier signal distributed via multi-function connection 105 to facilitate communications with power distribution unit 104. The data may include power information such as an identifier for power source 180, a rating for power source 180, and/or other power information received from other components of data processing system 102, such as power manager 182.

To manage power distribution to hardware resources 150, data processing system 102 may include power manager 182. Power manager 182 may manage power distribution to hardware resources 150 from power source 180 (e.g., supplied via power rail 184 and/or power rail 186). To do so, power manager 182 may communicate with power source 180 and/or management controller 152 via sideband channels 174. Power manager 182 may identify occurrences of power management events for data processing system 102. For example, power manager 182 may (i) communicate with management controller 152 regarding power states of hardware resources 150, (ii) monitor power consumption by hardware resources 150, and/or (iii) report changes in power consumption by power source 180 over time to management controller 152 and/or other components.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 are unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, power source 180 may separately supply power to the power rails (e.g., power rail 184, power rail 186) that power the respective power domains. Power from the power source 180 may be selectively provided to the separate power rails to selectively power the different power domains. Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

Turning to FIG. 1C, a diagram illustrating a power distribution system in accordance with an embodiment is shown. Power distribution unit 104 shown in FIG. 1C may be similar to any of the computing devices shown in FIG. 1A. The power distribution system may include power source 190, power distribution unit 104, and/or other components (not shown).

The power distribution system may distribute power to a deployment of data processing systems, such as deployment 198. Deployment 198 may include any number of data processing systems (e.g., similar to data processing system 102). For example, deployment 198 may be subdivided into groups (e.g., racks) of data processing systems for powering purposes. In FIG. 1C, a group of data processing systems is shown to include power sources 180A-180N. Power sources 180A-180N may be powered via power distribution unit 104 (e.g., a rack PDU).

Power distribution unit 104 may include any PDU included in the power distribution system. Power distribution unit 104 may include any number of power ports 192 (e.g., 192A-192N) by which power is provided to power sources (e.g., 180A-180N) via distinct multi-function connections. Power sources 180A-180N may be similar to power source 180 of FIG. 1B, and multi-function connections 105A-105N may be similar to multi-function connection 105 of FIG. 1B. For example, power port 192A may provide power from power distribution unit 104 to power source 180A via multi-function connection 105A, and power port 192N may provide power from power distribution unit 104 to power source 180N via multi-function connection 105N.

The multi-function connections (e.g., 105A-105N) may be adapted to supply power to connected power sources (e.g., of data processing systems) and facilitate communication between the power sources and power distribution unit 104. Transmission of data using the multi-function connections may be unidirectional or bidirectional. In a bidirectional example, power distribution unit 104 may transmit data (e.g., power information) and power to the power sources, and the power sources may transmit data to power distribution unit 104. However, in unidirectional examples, power distribution unit 104 may transmit power to the power sources, and either the power sources or power distribution unit 104 may transmit data to the other.

Power distribution unit 104 may obtain power via power connection 191 from power source 190. Power connection 191 may include any type of connection usable for transmitting power from power source 190 to power distribution unit 104. Power source 190 may include one or more components usable to convert utility level power (e.g., power from a utility power grid) to data center level power (e.g., power usable by a data center and/or to power any number of deployments (e.g., deployment 198) and/or data processing systems. For example, power source 190 may include a complicated architecture of one or more connected components (e.g., transformers, switches, power and/or bypass panels, power distribution units, batteries, back-up generators) and may connect to a large-scale source of power.

To manage power distribution from power source 190 to the group of power sources (e.g., 180A-180N), power distribution unit 104 may include power manager 194. Power manager 194 may manage a supply of power from power source 190 to power ports 192 via data channels 193. For example, power manager 194 may use data channels 193 to (i) monitor power consumption via each of power ports 192, (ii) perform load balancing tasks (e.g., across power ports 192), (iii) obtain data from power ports 192 (e.g., power information transmitted from the power sources), (iv) provide data to power ports 192 (e.g., power information for transmission to the power sources), and/or (v) perform other actions relating to power distribution and/or management.

For example, to obtain and/or transmit data, any of power ports 192 may include special hardware (e.g., filters, modulators, and/or other hardware circuitry, not shown) for encoding the power information onto a carrier signal of a corresponding multi-function connection and/or for decoding power information obtained via the carrier signal. Therefore, power manager 194 may manage and/or participate in the exchange of power information between a connected group of data processing systems and power distribution unit 104.

Power manager 194 may participate in providing power information to devices remote to power distribution unit 104. For example, power distribution unit 104 may include network components (not shown) and may be connected to a communication system (e.g., out-of-band communication system 106A of FIG. 1A). Power manager 194 may provide the power information (e.g., via communication channels, not shown) to a network component of power distribution unit 104 for transmission to a remote management system (e.g., an orchestrator).

For the purposes of clarity, the example shown in FIG. 1C includes one power distribution unit 104 powering one group (e.g., one rack) of power sources (e.g., 180A-180N) of deployment 198. However, in practice, it may be appreciated that a power distribution system may include a large number of PDUs (e.g., similar to power distribution unit 104), each providing power to other groups of power sources of deployment 198 not shown in FIG. 1C.

To further clarify embodiments disclosed herein, an interaction diagram in accordance with an embodiment is shown in FIG. 2. The interaction diagram may illustrate how data may be obtained and used within the system of FIGS. 1A-1C.

In the interaction diagrams, processes performed by and interactions between components of a (distributed) system in accordance with an embodiment are shown. In the diagrams, components of the system are illustrated using a first set of shapes (e.g., 150, 182, etc.), located towards the top of each figure. Lines descend from these shapes. Processes performed by the components of the system are illustrated using a second set of shapes (e.g., 200, 204) superimposed over these lines.

Interactions (e.g., communication, data transmissions, etc.) between the components of the system are illustrated using a third set of shapes (e.g., 202, 206) that extend between the lines. The third set of shapes may include lines terminating in arrows that may indicate one-way interactions (e.g., data transmission from a first component to a second component).

Thick arrows (e.g., sideband communication channel 174A, multi-function connection 105A) may indicate communication channels over which multi-way interactions are facilitated (e.g., data transmission between two components).

Generally, the processes and interactions are temporally ordered in an example order, with time increasing from the top to the bottom of each page. For example, the interaction labeled as 202 may occur prior to the interaction labeled as 206. However, it will be appreciated that the processes and interactions may be performed in different orders, any may be omitted, and other processes or interactions may be performed without departing from embodiments disclosed herein.

Turning to FIG. 2, an interaction diagram in accordance with an embodiment is shown. The interaction diagram may illustrate processes and interactions that may occur when managing power distribution to a data processing system. The data processing system (e.g., data processing system 102) may include hardware resources 150, power manager 182, and/or other components (not shown).

As discussed with respect to FIGS. 1A-1C, data processing system 102 may obtain power from a PDU (e.g., power distribution unit 104) via a multi-function connection (e.g., multi-function connection 105A) that connects a power source (not shown) of data processing system 102 to a power port (not shown) of power distribution unit 104.

To manage power distribution to data processing system 102, power information may be exchanged (e.g., bidirectionally) between components of the system, or power information may be provided from a first component of the system to a second component of the system. For example, data processing system 102 may report power information regarding power consumption by hardware resources 150 to power distribution unit 104 and/or power distribution unit 104 may report power information regarding power supplied by power distribution unit 104 to data processing system 102.

To provide power information regarding data processing system 102, power manager 182 may perform reporting process 200. During reporting process 200, power manager 182 may obtain power information for data processing system 102. For example, the power information may include (i) an identifier for power source 180 (e.g., usable to identify data processing system 102 and/or other components thereof), (ii) a rating for power source 180 (e.g., a maximum power output, an efficiency rating, a safety rating, an efficiency certification), (iii) information regarding power consumption by power source 180 (e.g., by hardware resources 150) over time, and/or (iv) other types of information relating to operation of and/or power distribution to hardware resources 150.

For example, the information regarding (current and/or anticipated) power consumption may be based on (i) a current powered state of data processing system 102 (e.g., portions of hardware resources 150 may be powered or depowered) and/or (ii) contents of a workload queue for hardware resources 150. Portions of the information regarding power consumption may be provided to power manager 182 by hardware resources 150 and/or out-of-band components of data processing system 102.

During reporting process 200, power manager 182 may package the power information and other data (e.g., cryptographic information, metadata for the power information such as time stamps) and/or otherwise prepare the power information for transmission to power distribution unit 104.

At interaction 202, power manager 182 may provide data (e.g., the packaged power information) to power distribution unit 104 over multi-function connection 105A via (i) transmission via a message, (ii) storing in a storage with subsequent retrieval by power distribution unit 104, (iii) a publish-subscribe system where power distribution unit 104 subscribes to updates from power manager 182 thereby causing a copy of the data to be propagated to power distribution unit 104, and/or (iv) other processes. To provide the data to power distribution unit 104, power manager 182 may provide the data to a power source of data processing system 102 (e.g., power source 180). As discussed with respect to FIG. 1C, the power source may include components and functionality for encoding the data onto a carrier signal of multi-function connection 105A.

To report power information regarding power distribution unit 104, power distribution unit 104 (e.g., a power manager of power distribution unit 104, similar to power manager 194 of FIG. 1C) may perform reporting process 204. During reporting process 204, power information for power distribution unit 104 may be obtained. For example, the power information may include (i) an identifier for power distribution unit 104 and/or the power port of power distribution unit 104 that facilitates multi-function connection 105A, (ii) a rating for power distribution unit 104 (e.g., a maximum power output, an efficiency rating, a safety rating, an efficiency certification), (iii) information regarding power supplied by power distribution unit 104 (e.g., by the power port) over time, and/or (iv) other types of information relating to power distribution by power distribution unit 104.

Reporting process 204 may be similar to reporting process 200. For example, during reporting process 204, a power manager of power distribution unit 104 may package the power information and other data (e.g., cryptographic information, metadata for the power information such as time stamps) and/or otherwise prepare the power information for transmission to data processing system 102.

At interaction 206, power distribution unit 104 may provide data (e.g., the packaged power information) to power manager 182 over multi-function connection 105A via (i) transmission via a message, (ii) storing in a storage with subsequent retrieval by power manager 182, (iii) a publish-subscribe system where power manager 182 subscribes to updates from power distribution unit 104 thereby causing a copy of the data to be propagated to power manager 182, and/or (iv) other processes. To obtain the data, a component (e.g., the power source) of data processing system 102 may filter (e.g., decode) data signal from a carrier signal obtained via multi-function connection 105A, thereby separating the data signal from power supplied by multi-function connection 105A.

Power distribution unit 104 may provide power to other data processing systems via distinct multi-function connections. Therefore, power distribution unit 104 may obtain power information from each connected data processing system and/or perform reporting processes for (e.g., transmit power information to) each of the connected data processing systems.

Reporting process 200 and/or reporting process 204 may be performed periodically over time. For example, a reporting process may be performed according to a predetermined schedule, based on occurrences of power management events for data processing system 102, and/or based on requests for power information (e.g., from any power-connected data processing systems and/or from remote devices operably connected to power distribution unit 104). Reporting process 200 and/or reporting process 204 may be performed while power is being distributed via multi-function connection 105A.

During reporting process 200 and/or reporting process 204, as power information is exchanged (or provided in one direction between power distribution unit 104 and power manager 182), policies for data processing system 102 may be triggered. For example, the policies may relate to power consumption by hardware resources 150, and may be keyed to variables such as: occurrences of power management events, changes in power consumption by hardware resources 150, changes in supply of power by power distribution unit 104, and/or other variables.

For example, the policies may include any number of thresholds (e.g., power consumption thresholds, power supply thresholds), and may be triggered based on a comparison of the power information (e.g., statistical characterizations thereof) with at least one of the thresholds. When a policy is triggered, a power management process may be initiated (e.g., by power distribution unit 104 and/or power manager 182).

To manage power distribution to data processing system 102 (and to other data processing systems connected to power distribution unit 104), power management process 208 may be performed. Power management process 208 may be performed independently and/or cooperatively by power manager 182 and/or power distribution unit 104. In some examples, power management process 208 may be performed in cooperation with a management system (e.g., an orchestrator) connected to data processing system 102 and/or power distribution unit 104 via an out-of-band communication system.

During power management process 208, a set of actions may be performed in order to determine quantities of power consumption by data processing system 102 and/or other data processing systems connected to power distribution unit 104 over time. For example, a triggered policy may specify different powered states for data processing system 102, priorities for power distribution (e.g., prioritized data processing systems of the deployment), and/or actions that may be performed in order to manage changes in power consumption and/or supply over time.

For example, during power management process 208, limits of power consumption for data processing system 102 may be obtained. The limits of power consumption may include, for example, (i) minimum and/or maximum limits on power required by data processing system 102 over time (e.g., based on workload queue and/or other factors), and/or (ii) minimum and/or maximum amounts of available power from power distribution unit 104 over time.

The minimum and/or maximum amounts of available power from power distribution unit 104 may be based on limits of power consumption for other data processing systems that rely on power distribution unit 104 for power (e.g., other data processing systems connected to power distribution unit 104). In other words, while power management process 208 is being performed for data processing system 102, power distribution unit 104 may perform other power management processes for other connected data processing systems in order to optimize power distribution among the connected data processing systems in accordance with their policies.

Based on the limits of power consumption, power distribution to data processing system 102 (and/or the other connected data processing systems) may be limited by power distribution unit 104, and/or by the data processing systems in accordance with the policies. For example, a new powered state for data processing system 102 and the other data processing systems may be defined based on the limits of power consumption.

For example, power information provided by data processing system 102 may indicate that power consumption by hardware resources 150 will increase at a future period in time, beyond a threshold associated with a high-powered state as defined by a policy. If power information provided by power distribution unit 104 indicates that power distribution unit 104 is able to meet power supply requirements for the high-powered state, then the policy may specify actions for placing data processing system 102 into the high-powered state. And, for example, depending on power distribution factors (e.g., workload priorities), the policy may specify actions for placing a portion of the other data processing systems connected to power distribution unit 104 into low-powered states in order to accommodate the new high-powered powered state for data processing system 102.

To enforce the policies (e.g., the new powered state for data processing system 102), the actions defined by the policy may be provided to hardware resources 150 (and/or other components of data processing system 102, such as a management controller) for performance.

At interaction 210, power manager 182 may provide the actions to hardware resources 150 (and/or the other components) over sideband communication channel 174A via (i) transmission via a message, (ii) storing in a storage with subsequent retrieval by hardware resources 150, (iii) a publish-subscribe system where hardware resources 150 subscribes to updates from power manager 182 thereby causing a copy of the actions to be propagated to hardware resources 150, and/or (iv) other processes.

The actions may be performed to update power consumption by hardware resources 150 over time. For example, the actions may include (i) powering or depowering components of hardware resources 150 (e.g., a graphics processing unit), (ii) powering and/or depowering portions of components of hardware resources 150 (e.g., a core of a multi-core processor), (iii) adjusting configuration parameters for portions of hardware resources 150 (e.g., modifying clock frequencies), (iv) suspending performance of workloads (e.g., for a period of time), and/or (v) otherwise modifying power consumption by hardware resources 150. The actions may include instructions executable by various components of hardware resources 150.

During power management process 208, data processing system 102 and/or power distribution unit 104 may provide information to other entities (e.g., to a management system via an out-of-band communication system, not shown) when higher-level power distribution management is required.

For example, if policies conflict (e.g., when power distribution unit 104 is unable to supply an amount of power required by all or any of the connected data processing systems in accordance with policies), then a management entity may be notified. The management entity may analyze the power information and find solutions for resolving the policy conflict. For example, the management entity may perform high-level power management tasks, such as adjusting workload distribution across the deployment and/or proposing architectural modifications to the power distribution system.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIG. 2, power distribution for a deployment of data processing systems may be managed based on an exchange of power information over existing power connections for the data processing systems. By doing so, power distribution to (e.g., power consumption by) the data processing systems may be managed in a timely (e.g., near real-time) manner, without requiring additional connectivity (e.g., network connections) for exchanging the power information.

Turning to FIG. 3, a flow diagram illustrating a method in accordance with an embodiment is shown. The flow diagram may illustrate various operations performed when managing a data processing system.

The data processing system may belong to a deployment of data processing systems. A PDU may supply power to at least the data processing system using a multi-function connection (e.g., the PDU may also supply power to other data processing systems of the deployment via distinct multi-function connections). The multi-function connection may be adapted to both supply power to the data processing system and facilitate communication between the data processing system and the PDU.

At operation 300, an identification of an occurrence of a power management event for the data processing system may be made. The identification may be made by analyzing information regarding power supplied by the PDU and/or consumed by the data processing system (e.g., over time) with respect to policies for the data processing system.

For example, a power manager of the data processing system may make the identification by (i) analyzing workload information (e.g., process queues) of the data processing system to identify workload types (e.g., heavy workloads, light workloads) and/or quantities of power consumption associated with the workload types over time, and/or (ii) analyzing power information obtained from (e.g., reported by) the PDU to identify quantities of power available (to the data processing system) over time.

The identification may be made (e.g., by the power manager) by obtaining notifications from other entities (e.g., the PDU, a management system for the deployment, another component of the data processing system) indicating occurrence of the event and/or by other methods. For example, a user or administrator of the data processing system may report an occurrence (e.g., a predicted occurrence) of the power management event and the notification may be provided to the data processing system from the management system via out-of-band communication channels and/or in-band communication channels of the data processing system. Refer to the discussion of FIG. 2 for more details regarding identification of power management events.

At operation 302, based on the identification, a power information exchange process may be performed with the PDU using the multi-function connection to exchange power information. The power information exchange process may be performed by encoding data onto a carrier signal distributed via the multi-function connection to facilitate the exchange of power information and/or by other methods. For example, while power is being distributed by the multi-function connection, a data package including the power information may be encoded onto the carrier signal using an encoding technique that modulates the carrier signal to reflect information in the data package.

Performing the power information exchange process may include (i) transmitting a first modulated carrier signal from the data processing system (e.g., from a power source of the data processing system) to the PDU, and/or (ii) obtaining (e.g., by the power source of the data processing system) a second modulated carrier signal from the PDU. For example, the first modulated carrier signal may be decoded (e.g., by a component of the PDU) to obtain power information regarding the data processing system, and the second modulated carrier signal may be decoded (e.g., by a component of the power source) to obtain power information regarding the PDU.

At operation 304, a power management process may be performed using the power information to obtain a new powered state for the data processing system. The power management process may be performed by (i) obtaining limits of power consumption for the data processing system, (ii) defining the new powered state for the data processing system based on the limits of power consumption, and/or (iii) by other methods. The power management process may be performed by the data processing system, the PDU, and/or another entity (e.g., a remote management system, an orchestrator).

Obtaining the limits of power consumption for the data processing system may include (i) obtaining a minimum and/or maximum amount of power required by the data processing system over time (e.g., based on a workload queue for hardware resources of the data processing system), (ii) obtaining a rating for the power source of the data processing system, (iii) obtaining a minimum and/or maximum amount of power available to the data processing system over time (e.g., based on power information regarding the PDU), and/or (iv) obtaining other limits and/or restrictions relating to power distribution to the data processing system and/or other data processing systems of the deployment. Obtaining the limits of power consumption may include obtaining statistical characterization thereof.

Defining the new powered state for the data processing system may include (i) analyzing (e.g., comparing) the limits of power consumption (e.g., the statistical characterizations thereof) with thresholds specified by policies of the data processing system, and/or (ii) identifying policies for enforcement based on the analysis. For example, the policies may define the new powered state for the data processing system and/or may include actions for enforcing the new powered state on the hardware resources.

At operation 306, the new powered state may be enforced on at least hardware resources of the data processing system to obtain an updated data processing system. The new powered state may be enforced by (i) obtaining the actions for enforcing the new powered state, (ii) providing a first portion of the actions to components of the data processing system (e.g., to a processor, via a sideband communication channel), (iii) providing a second portion of the actions to a remote system (e.g., to a management system for the deployment, via an out-of-band communication channel), (iv) performing a third portion of the actions, and/or (v) by other methods.

For example, once any portion of the actions is performed, operation of hardware resources of the data processing system may be updated (e.g., via depowering and/or powering portions of components of the hardware resources), thereby updating (operation of) the data processing system.

At operation 308, computer-implemented services may be provided using the updated data processing system. The computer-implemented service may be provided by (i) obtaining instructions (e.g., user input, instructions from another device, instructions generated by software components of the hardware resources), and/or (ii) executing the instructions using (powered portions of) the hardware resources of the updated processing system.

The method may end following operation 308.

Thus, as illustrated above, embodiments disclosed herein may provide systems and methods for managing data processing systems using power-based communications. By using existing multi-function connections that power the data processing systems to automatically transmit power information and facilitate power distribution management processes, additional types of connections and/or manual efforts may not be required to optimize power distribution to the data processing systems.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
making an identification, by a power manager of the data processing system, of an occurrence of a power management event for the data processing system; and
based on the identification:
performing, by the data processing system and using a multi-function connection, a power information exchange process with a power distribution unit (PDU) that supplies power to at least the data processing system, the multi-function connection being adapted to both supply power to the data processing system and facilitate communication between the data processing system and the PDU to exchange power information,
performing, by at least the data processing system, a power management process using the power information to obtain a new powered state for the data processing system,
enforcing the new powered state on at least hardware resources of the data processing system to obtain an updated data processing system, and
providing, using the updated data processing system, computer-implemented services.

2. The method of claim 1, wherein the PDU is connected to at least two data processing systems via distinct multi-function connections.

3. The method of claim 2, wherein the PDU is adapted to obtain data center level power and supply power source level power via the distinct multi-function connections.

4. The method of claim 1, wherein the data processing system is connected to the PDU via an out-of-band communication channel that runs through a network module of the data processing system and the out-of-band communication channel services a management controller of the data processing system.

5. The method of claim 4, wherein the data processing system is connected to at least one other entity via an in-band communication channel that also runs through the network module and the in-band communication channel services the hardware resources.

6. The method of claim 1, wherein the power information exchange process is performed while power is being distributed via the multi-function connection.

7. The method of claim 6, wherein performing the power information exchange process comprises:
encoding data onto a carrier signal distributed via the multi-function connection to facilitate the exchange of the power information.

8. The method of claim 1, wherein the power information comprises at least one selected from a group consisting of:
an identifier for the PDU;
an identifier for a power source of the data processing system;
a rating for the PDU;
a rating for the power source;
information regarding power supplied by the PDU over time; and
information regarding power consumption by the power source over time.

9. The method of claim 1, wherein the power management process comprises:
obtaining limits of power consumption for the data processing system; and
defining the new powered state for the data processing system based on the limits of the power consumption.

10. A non-transitory machine-readable medium having instructions stored therein, which when executed by a processor, cause the processor to perform operations for managing a data processing system, the operations comprising:
making an identification, by a power manager of the data processing system, of an occurrence of a power management event for the data processing system; and
based on the identification:
performing, by the data processing system and using a multi-function connection, a power information exchange process with a power distribution unit (PDU) that supplies power to at least the data processing system, the multi-function connection being adapted to both supply power to the data processing system and facilitate communication between the data processing system and the PDU to exchange power information,
performing, by at least the data processing system, a power management process using the power information to obtain a new powered state for the data processing system,
enforcing the new powered state on at least hardware resources of the data processing system to obtain an updated data processing system, and
providing, using the updated data processing system, computer-implemented services.

11. The non-transitory machine-readable medium of claim 10, wherein the PDU is connected to at least two data processing systems via distinct multi-function connections.

12. The non-transitory machine-readable medium of claim 11, wherein the PDU is adapted to obtain data center level power and supply power source level power via the distinct multi-function connections.

13. The non-transitory machine-readable medium of claim 10, wherein the data processing system is connected to the PDU via an out-of-band communication channel that runs through a network module of the data processing system and the out-of-band communication channel services a management controller of the data processing system.

14. The non-transitory machine-readable medium of claim 13, wherein the data processing system is connected to at least one other entity via an in-band communication channel that also runs through the network module and the in-band communication channel services the hardware resources.

15. The non-transitory machine-readable medium of claim 10, wherein the power information exchange process is performed while power is being distributed via the multi-function connection.

16. A data processing system, comprising:
a processor; and
a memory coupled to the processor to store instructions, which when executed by the processor, cause operations for managing the data processing system to be performed, the operations comprising:
making an identification, by a power manager of the data processing system, of an occurrence of a power management event for the data processing system, and
based on the identification:
performing, by the data processing system and using a multi-function connection, a power information exchange process with a power distribution unit (PDU) that supplies power to at least the data processing system, the multi-function connection being adapted to both supply power to the data processing system and facilitate communication between the data processing system and the PDU to exchange power information;
performing, by at least the data processing system, a power management process using the power information to obtain a new powered state for the data processing system;
enforcing the new powered state on at least hardware resources of the data processing system to obtain an updated data processing system; and
providing, using the updated data processing system, computer-implemented services.

17. The data processing system of claim 16, wherein the PDU is connected to at least two data processing systems via distinct multi-function connections.

18. The data processing system of claim 17, wherein the PDU is adapted to obtain data center level power and supply power source level power via the distinct multi-function connections.

19. The data processing system of claim 16, wherein the data processing system is connected to the PDU via an out-of-band communication channel that runs through a network module of the data processing system and the out-of-band communication channel services a management controller of the data processing system.

20. The data processing system of claim 19, wherein the data processing system is connected to at least one other entity via an in-band communication channel that also runs through the network module and the in-band communication channel services the hardware resources.
